(19) United States
(12) Patent Application Publication
(10) Pub. No.: US 2026/0296228 A1
(43) Pub. Date: Oct. 1, 2026

(54) ELECTRICAL CHARGING SOCKET WITH ELECTRIC SHOCK PREVENTION MEMBER

(71) Applicant: AMPERE S.A.S., Boulogne Billancourt (FR)

(72) Inventor: Clement LHOMME, Guyancourt Cedex (FR)

(73) Assignee: AMPERE S.A.S., Boulogne Billancourt (FR)

(21) Appl. No.: 19/132,644

(22) PCT Filed: Nov. 27, 2023
(86) PCT No.: PCT/EP2023/083110

§ 371 Date: May 15, 2026

(30) Foreign Application Priority Data
Nov. 29, 2022 (FR) FR2212528

(51) Int. Cl. B60L 53/16; H01R 13/53

(52) U.S. Cl. CPC B60L 53/16; H01R 13/53; H01R 2201/26

(57) ABSTRACT

An electrical charging socket is for a motor vehicle. The socket has a connection face and an interface face. The socket includes at least one cylindrical cavity, a retaining cylinder arranged in the cylindrical cavity, and an electrical connection member arranged in the retaining cylinder. The socket also includes an electric shock prevention member associated with one end of the electrical connection member in the vicinity of the connection face and including a peripheral portion and a membrane. The electric shock prevention member has a protection position in which the membrane is flat and a connection position in which the membrane is deformed toward the interior of the retaining cylinder.

The present invention relates to the field of the automotive industry and more particularly of electrical charging systems for motor vehicles, such systems being installed on hybrid or electric vehicles.

These hybrid or electric vehicles generally comprise an electrical energy storage unit such as a battery, which makes it possible to supply the vehicle with electrical energy to be transformed into mechanical power necessary for a powertrain to drive the vehicle. When the vehicle is running, the energy stored in this battery decreases, and it then needs to be recharged by the user, for example by being regularly connected to an electrical network.

There exists, to this end, charging equipment such as wall terminals, also referred to as wallboxes, which make it possible to recharge the battery of the vehicle. These wall terminals may comprise a charging cable for connection to the vehicle via a connection device, for example an electrical charging plug, such an electrical charging plug being configured to cooperate with a complementary electric socket of the hybrid or electric vehicle.

Once the electrical charging plug is connected to the wall terminal, an electrical current can be passed through the cable, notably to electrical pins of the electrical charging plug. The electrical charging plug may thus present risks of electric shocks or electrocution, for example if a user's finger makes contact with the electrical charging plug and an electrical pin thereof.

In this context, the main subject of the present invention is thus an electrical charging plug for a motor vehicle, comprising a plug fitting with a coupling side, an interface side and at least one cylindrical cavity extending mainly in a longitudinal direction and passing through the plug fitting from the coupling side to the interface side, the electrical charging plug comprising a retaining cylinder disposed in the cylindrical cavity and an electrical connector disposed in the retaining cylinder, an end of the electrical connector being adjacent to the coupling side, the electrical charging plug comprising an electric shock preventer associated with the end of the electrical connector and comprising a peripheral portion and a diaphragm, the electric shock preventer being configured to have a protection position in which the diaphragm is substantially flat and a coupling position in which the diaphragm is deformed toward an interior of the retaining cylinder.

The electrical charging plug according to the invention is intended for electrically recharging a vehicle, more specifically an electric vehicle. The plug comprises a plug fitting which is a connection device, one side of which is a coupling side configured to cooperate with an electrical charger of the vehicle, for example a complementary charging socket, and the other side of which is an interface side configured to cooperate with a wall terminal, for example via a charging cable. A cylindrical cavity which receives a retaining cylinder, itself receiving an electrical connector, passes all the way through the plug fitting. Such an electrical connector is for example a pin for establishing electrical contact with a prong of the charging socket disposed on the vehicle.

An electric shock preventer is associated with the end of the electrical connector; this is understood to mean that the preventer cooperates with this end. This electric shock preventer comprises a peripheral portion which contributes to holding it in position with respect to the retaining cylinder, and also a flexible and deformable diaphragm.

Such a deformation of the diaphragm allows it to take either a protection position, in which it forms a substantially flat disk and prevents any contact between the electrical connector and a finger of a user of the electrical charging plug, or a coupling position, under the effect of a pressure, in which the prong of the electrical charger of the vehicle can pass through the diaphragm. In this coupling position, the diaphragm is no longer flat; it deforms when the prong bears against it, in such a way that the diaphragm extends toward an interior of the retaining cylinder.

According to one feature of the invention, the electric shock preventer is disposed, in the longitudinal direction, between the retaining cylinder and a wall of the cylindrical cavity that faces the end of the electrical connector.

A first embodiment of the electrical charging plug is when the electric shock preventer is disposed between the retaining cylinder and a wall of the cylindrical cavity. In this first embodiment, the electric shock preventer is held in place by being pressed between these two elements.

According to an alternative feature of the invention, the electric shock preventer and the retaining cylinder form a one-piece assembly.

This is a second embodiment, in which the electric shock preventer and the retaining cylinder form a one-piece component which may for example be obtained by overmolding. In this case, the peripheral portion is formed by an inner wall of the retaining cylinder.

According to one feature, the electrical connector has a tubular shape with an internal face and an external face, the internal face being equipped with bosses configured to be in contact with a prong of an electrical charger, the bosses being disposed at a distance from the end associated with the electric shock preventer.

According to one feature of the invention, in the coupling position, the diaphragm is at a distance from the bosses.

This is understood to mean that there is a longitudinal offset between the bosses and the end with which the electric shock preventer is associated. Such an offset makes it possible to avoid contact between the bosses and the diaphragm when the latter is in the coupling position, and thus prevent the electric shock preventer from being a barrier between the bosses and the prong of the electrical charger.

According to one feature, the diaphragm comprises slits configured to deform when the prong of the electrical charger passes through.

The diaphragm more specifically comprises strips which are separated from one another by slits. In the coupling position, these slits deform and open up such that the strips move away from one another, thus allowing the prong of the electrical charger to pass through.

According to another feature of the invention, the diaphragm comprises a central opening, the slits extending in the shape of a star from this central opening.

Within the electric shock preventer, the diaphragm extends from the peripheral portion to the central opening. The slits extend from this central opening toward the peripheral portion, and they are disposed at regular angles with respect to one another such that they form a star shape.

According to one feature, the slits widen as they get further away from the central opening.

According to an alternative feature, the slits have a constant width as they get further away from the central opening.

It will be understood in this case that there are two separate embodiments for the slits: a first embodiment in which they become wider from the central opening to the peripheral portion, and a second embodiment in which their width stays the same irrespective of the point at which it is measured.

According to one feature of the invention, between them the slits define strips articulated on the peripheral portion.

According to another feature of the invention, edges of the strips which define the central opening are rounded.

The strips thus do not have projecting edges which could impede the insertion of the prong of the electrical charger.

According to another feature, the diaphragm is made of rubber.

The diaphragm is thus made of a flexible and deformable material. The rubber is preferably a silicone rubber with a shore A hardness of between 25 and 100.

According to one feature of the invention, the electrical charging plug comprises a plurality of retaining cylinders each of which contains an electrical connector, each retaining cylinder being connected, on the interface side, to at least one other retaining cylinder by a connecting tab.

The retaining cylinders are thus arranged within the plug fitting in a spiderweb arrangement, and it is possible for each connecting tab to join two or more retaining cylinders to one another. Such an arrangement requires additional machining, i.e. the formation of the connecting tab, but makes it possible to insert all the retaining cylinders in a single assembly step and in this regard constitutes a saving on time.

According to another feature, the connecting tab extends in a slot of the interface side. This slot corresponds to a hollow portion of the interface side which extends between two adjacent retaining cylinders.

The invention further relates to a method for assembling an electrical charging plug as described above, comprising a step of inserting the electric shock preventer into the cylindrical cavity of the plug fitting, a step of inserting the retaining cylinder into this cylindrical cavity, and a clamping step, during which the electric shock preventer is pressed against the wall of the cylindrical cavity by the retaining cylinder.

This assembly method corresponds to the first embodiment of the electrical charging plug, i.e. that in which the electric shock preventer is disposed between both the retaining cylinder and the wall of the cylindrical cavity.

As an alternative, the invention relates to a method for assembling an electrical charging plug as described above, comprising a step of overmolding the electric shock preventer onto the retaining cylinder, and a step of inserting an assembly formed by the retaining cylinder and the electric shock preventer into the cylindrical cavity of the plug fitting.

This alternative to the assembly method corresponds to the second embodiment of the electrical charging plug, i.e. that in which the electric shock preventer is disposed within the retaining cylinder. The overmolding makes it possible in this case to avoid an assembly operation.

Further features, details and advantages of the invention will become more clearly apparent from reading the following description, and from exemplary embodiments given by way of nonlimiting indication, with reference to the appended drawings, in which:

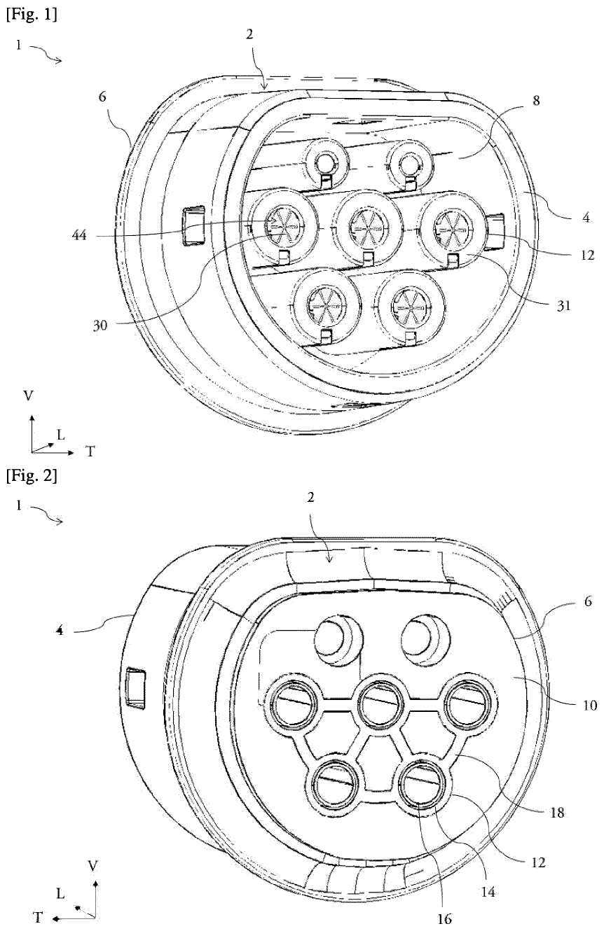

FIG. 1 schematically illustrates a perspective view of an electrical charging plug according to the invention, a coupling side of this electrical charging plug being visible;

FIG. 2 schematically illustrates a perspective view of the electrical charging plug in FIG. 1, an interface side of this electrical charging plug being visible;

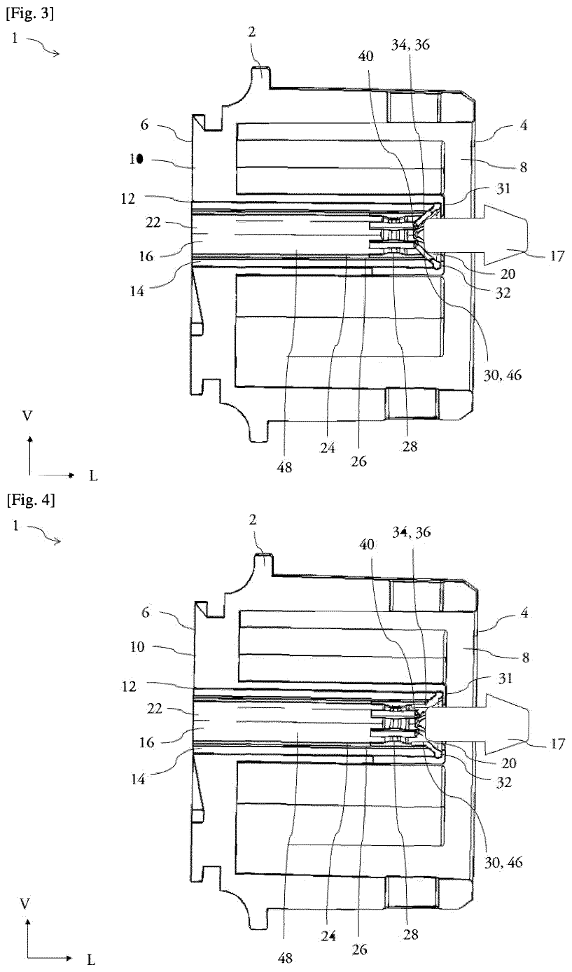

FIG. 3 schematically illustrates a sectional view of the electrical charging plug in FIG. 1, a prong of an electrical charger being partially inserted therein;

FIG. 4 schematically illustrates another sectional view of the electrical charging plug in FIG. 1, the prong of an electrical charger being completely inserted therein;

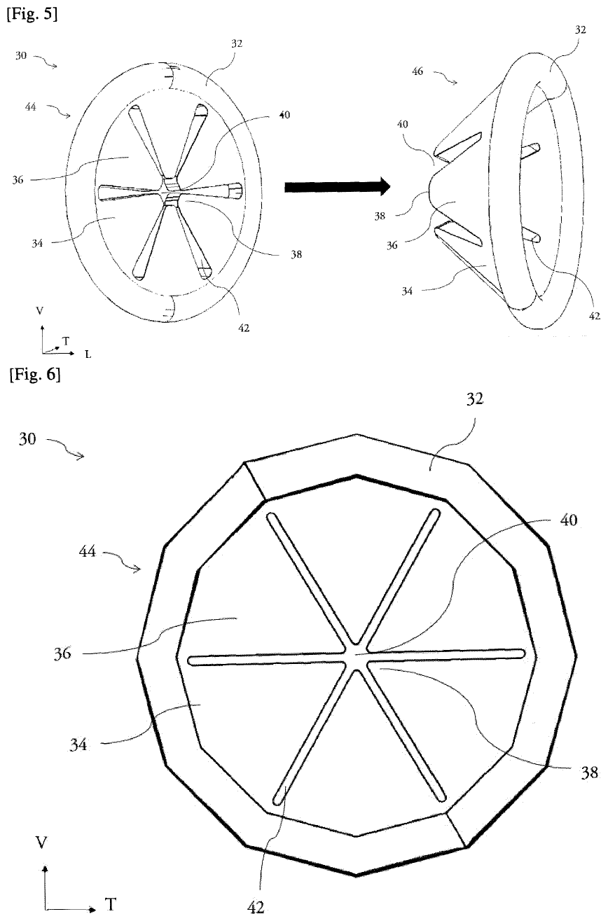

FIG. 5 schematically illustrates a protection position and a coupling position of an electric shock preventer of the electrical charging plug in FIG. 1, which is shown here according to a first embodiment;

FIG. 6 schematically illustrates the electric shock preventer in FIG. 5 according to a second embodiment.

The features, variants and various embodiments of the invention may be combined with one another, in various combinations, as long as they are not mutually incompatible or mutually exclusive. It will be possible, in particular, to imagine variants of the invention that comprise only a selection of features described below, in isolation from the other features described, if this selection of features is sufficient to provide a technical advantage and/or to differentiate the invention from the prior art.

In the figures, elements that are common to several figures retain the same reference.

In the following detailed description, the designations “longitudinal”, “transverse” and “vertical” refer to the orientation of the electrical charging plug according to the invention. A longitudinal direction corresponds to a main direction of extent of a cylindrical cavity of the electrical charging plug, this longitudinal direction being parallel to a longitudinal axis L of a frame of reference L, V, T illustrated in the figures. A vertical direction corresponds to a direction perpendicular to the ground on which a motor vehicle that is to be electrically recharged via the electrical charging plug rests, this vertical direction being parallel to a vertical axis V of the frame of reference L, V, T and this vertical axis V being perpendicular to the longitudinal axis L. Lastly, a transverse direction corresponds to a direction parallel to a transverse axis T of the frame of reference L, V, T, this transverse axis T being perpendicular to the longitudinal axis L and to the vertical axis V.

FIGS. 1 and 2 thus schematically illustrate a perspective view of an electrical charging plug 1 according to the invention. This electrical charging plug 1 is intended to be fitted to a hybrid or electric motor vehicle in order to electrically recharge a battery of the motor vehicle.

The electrical charging plug 1 has a plug fitting 2 which extends longitudinally between a coupling side 4, particularly visible in FIG. 1, and an interface side 6, particularly visible in FIG. 2. The coupling side 4 is configured to be connected to a complementary electrical charger of the motor vehicle, whereas the interface side 6 is intended to be connected to a wall socket via a charging cable.

The plug fitting 2 has an internal space 8 delimited on the interface side 6 by a transverse wall 10. Conversely, the internal space 8 is open toward an exterior of the electrical charging plug 1 on the coupling side 4. The internal space 8 contains at least one cylindrical cavity 12. This cylindrical cavity 12 extends mainly in a longitudinal direction L. It passes all the way through the plug fitting 2, i.e. from the coupling side 4 to the interface side 6.

More specifically, the electrical charging plug 1 in this case comprises seven cylindrical cavities 12. There is thus a central cylindrical cavity 12 around which six other cylindrical cavities 12 are disposed in the shape of a star. It is thus possible to define two upper cylindrical cavities 12 disposed on a single longitudinal-vertical plane, three middle cylindrical cavities 12, including the central cylindrical cavity 12, which are disposed on a single longitudinal-vertical plane, and two lower cylindrical cavities 12 which are themselves also disposed on a single longitudinal-vertical plane. The lower and middle cylindrical cavities 12 have similar diameters, whereas the upper cylindrical cavities 12 have smaller diameters.

As will be described more specifically later on, the upper cylindrical cavities 12 receive elements which contribute to control functions when the motor vehicle is being electrically charged. The lower and middle cylindrical cavities 12, for their part, receive elements dedicated to transmitting a single-phase or three-phase electrical current, or neutral elements or elements connected to ground. The features that will now be described in relation to one of the cylindrical cavities 12 are intended to be applied, unless stated otherwise, to any one of the middle or lower cylindrical cavities 12.

Each cylindrical cavity 12 contains a retaining cylinder 14 extending mainly in the longitudinal direction L. This retaining cylinder 14 receives an electrical connector 16 of the electrical charging plug 1. The retaining cylinder 14 is for example made of a plastic, and it makes it possible to ensure this connector 16 is held in position within the plug fitting 2. Such an electrical connector 16 takes the form for example of a pin intended to cooperate with a prong 17 of the complementary electrical charger disposed on the vehicle, notably by transmitting an electrical current to it. Such a prong 17 of the electrical charger is schematically shown in FIGS. 3 and 4.

On the interface side 6, and as illustrated in FIG. 2, the retaining cylinders 14 are connected to one another via connecting tabs 18, which are material extensions of these retaining cylinders 14. More specifically, each of the retaining cylinders 14 is connected to at least one other retaining cylinder via such a connecting tab 18. The retaining cylinder 14 disposed in the central cylindrical cavity 12 is for example connected to four other cylindrical cavities 12 by four connecting tabs 18, whereas the retaining cylinders 14 of the lower cylindrical cavities 12 are respectively connected by three connecting tabs 18 to three other cylindrical cavities 12. Each connecting tab 18 extends in a slot machined to this end in the interface side 6, and more particularly in the transverse wall 10 of this interface side 6, such that the connecting tab 18 does not project from the transverse wall 10. The connecting tabs 18 in this case connect the retaining cylinders 14 in a spiderweb arrangement.

The electrical connector 16 extends within the retaining cylinder 14 between a first end 20 next to the coupling side 4 and a second end 22 next to the interface side 6. As shown particularly clearly in FIGS. 3 and 4, which are sectional views of the electrical charging plug 1, the electrical connector 16 is in the form of a tube. This electrical connector thus has an external face 24 in contact with the retaining cylinder 14 and an internal face 26 situated opposite the external face 24. The internal face 26 is deformed such that it has bosses 28, which are configured to come into contact with the prong 17 of the electrical charger of the vehicle in order to transmit an electrical current to it.

Such bosses 28 are closer to the first end 20 than to the second end 22, but are nevertheless disposed at a distance from this first end 20.

According to the invention, the electrical charging plug 1 comprises an electric shock preventer 30. The role of such an electric shock preventer 30 is to avoid an electric shock, or even electrocution, that might result from contact between the bosses of one of the electrical connectors 16 and a finger of a user of the electrical charging plug 1, without impeding the passage of the prong 17 of the electrical charger of the vehicle.

The electric shock preventer 30 is to this end associated with the first end 20 of the electrical connector 16. Such an association can manifest itself, according to the embodiments, either in the electric shock preventer being pressed against this first end 20, or by being overmolded therein. Specifically, there is a first embodiment of the electrical charging plug 1 in which the electric shock preventer 30 is disposed, in the longitudinal direction, between the retaining cylinder 14 and a wall of the cylindrical cavity 12. Such a wall is in this case a transverse wall 31 of the cylindrical cavity 12 on the coupling side 4, which faces the first end 20 of the electrical connector and is substantially parallel to the transverse wall 10 of the interface side 6. It will be understood that in this first embodiment, the electric shock preventer 30 is clamped between the transverse wall 31 and the retaining cylinder 14. Such a first embodiment is particularly visible in FIGS. 3 and 4. As an alternative, in a second embodiment not shown here, the electric shock preventer 30 and the retaining cylinder 14 may form a one-piece assembly. In this case, the electric shock preventer 30 and the retaining cylinder 14 are overmolded one onto the other so as to form a one-piece component.

The electric shock preventer 30 will now be described in relation to FIGS. 5 and 6, which illustrate various configurations and various embodiments. The electric shock preventer 30 is in the form of a disk and comprises a peripheral portion 32 forming a bulge which surrounds a diaphragm 34. Such a diaphragm 34 has a diameter substantially equal to a diameter of the electrical connector 16. It is made of a flexible and deformable material, for example rubber. This rubber is preferably a silicone rubber with a Shore A hardness of between 25 and 100. The peripheral portion 32 contributes to holding the electric shock preventer 30 in position, whether against the retaining cylinder 14 in the first embodiment of the electrical charging plug 1 or within the retaining cylinder 14 in the second embodiment. In this second embodiment, the peripheral portion 32 can further be formed at least partially by an inner wall of the retaining cylinder 14.

The diaphragm 34 comprises elastic strips 36 which have an approximately triangular shape. These elastic strips 36 are articulated on the peripheral portion 32; in other words, they extend from this peripheral portion 32. They thus have an edge which is connected to the peripheral portion 32, and a rounded free edge 38 which defines a central opening 40 within the diaphragm 32. Such a central opening 40 corresponds to an aperture within the diaphragm 32. Slits 42 which delimit two adjacent elastic strips 36 extend from this central opening 40. It will thus be understood that a shape of the elastic strips 36 depends on how the slits 42 are cut and how they are arranged within the diaphragm 34. These slits 42 in this case extend in the shape of a star from the central opening 40, toward the peripheral portion 32 but without making contact therewith.

FIGS. 5 and 6 correspond to two separate embodiments of the slits 42, with respectively a first embodiment shown in FIG. 5 and a second embodiment illustrated in FIG. 6. In their first embodiment, the slits 42 have a width which increases as they get further away from the central opening 40; in other words, these slits 42 are thinner in the vicinity of the central opening 40 than they are in the vicinity of the peripheral portion 32. Conversely, in their second embodiment, the slits 42 have a constant width. Whether in their first embodiment or in their second embodiment, the slits 42 have rounded ends, thereby allowing a better articulation of the elastic strips 36 and limiting the risks of the diaphragm 34 tearing at this location.

Such an articulation of the elastic strips 36 is important because the electric shock preventer 30 is deformable such that it alternates between two positions, both of which are illustrated in FIG. 5. The electric shock preventer 30 thus has a protection position 44, or rest position, which prevents contact between a user's finger and one of the electrical connectors 16 of the electrical charging plug 1. In this protection position 44, which is also visible in FIG. 1, the diaphragm 34 is substantially flat. This is understood to mean that the peripheral portion 32 and the central opening 40 are substantially disposed in a single plane. The electric shock preventer 30 may also take a coupling position 46 or stressed position, also shown in FIGS. 3 and 4, which permits electrical contact between the electrical connector 16 and the prong 17 of the electrical charger of the vehicle. In this coupling position 46, the diaphragm 34 is deformed such that it extends at least partially toward an interior 48 of the retaining cylinder. Such a deformation is the result of a pressure exerted by the prong 17 when it passes through the central opening 40. It will be understood that in this coupling position 46, the diaphragm 34 is no longer flat; the slits 42 deform and open up as the prong 17 passes through, thus contributing to moving the elastic strips 36 away from one another and to making them extend into the interior 48 of the retaining cylinder, toward the second end 22, as shown particularly clearly in FIG. 4. Since the free edges 38 of the elastic strips 36 which border the central opening 40 have, as mentioned above, a rounded shape, it is easier to insert the prong 17 through this central opening 40.

As illustrated in FIGS. 3 and 4, which are respectively a view in which the prong 17 is partially inserted through the central opening 40 and a view in which this prong 17 is in contact with the bosses 28 after having been completely inserted, in the coupling position 46 the diaphragm 34 and notably its elastic strips 36 are at a distance from the bosses 28. Specifically, there is a longitudinal offset between these bosses 28 and the first end 20 with which the electric shock preventer 30 is associated. Such a longitudinal offset makes it possible to avoid interference by the electric shock preventer 30 between the bosses 28 and the prong 17 of the electrical charger of the motor vehicle, which would disrupt the transmission of electrical current and especially the recharging of the vehicle. As a result, when the prong 17 is pushed through the central opening 40 of the diaphragm 34, the elastic strips 36 of this diaphragm 34 deform and are pressed against the internal face 26 of the electrical connector 16, the longitudinal offset ensuring that, when this happens, they are not in contact with the bosses 28.

A method for assembling the electrical charging plug 1 according to the invention will now be described, for each of the two embodiments mentioned above.

In the first embodiment, which is that for which the electric shock preventer 30 is disposed between the retaining cylinder 14 and the transverse wall 31 of the cylindrical cavity 12, the assembly method is preceded by a step of manufacturing the electric shock preventer 30 so the slits 42 either have an increasing width as in their first embodiment, or have a constant width as in their second embodiment. The assembly method comprises a step of inserting this electric shock preventer 30 into the cylindrical cavity 12 of the plug fitting 2, and then a step of inserting the retaining cylinder 14 into this cylindrical cavity 12. If there are a plurality of retaining cylinders 14, the insertion step will be complete when the connecting tabs 18 of these retaining cylinders 14 abut the slots intended to receive them on the transverse wall 10 of the interface side. The retaining cylinders 14 will also abut the electric shock preventer 30, which itself abuts the transverse wall 31. The assembly method subsequently comprises a clamping step, during which the electric shock preventer 30 is pressed against the transverse wall 31 of the cylindrical cavity 12 by the retaining cylinder 14. Such a clamping step makes it possible to ensure that there is no play between the transverse wall 31 and the electric shock preventer 30 on the one hand, and between this electric shock preventer 30 and the retaining cylinder 14 on the other hand. The assembly method then comprises a step of inserting the electrical connector 16 into its retaining cylinder 14, the latter then being able to come into contact, via its bosses 28, with the prong 17 of the electrical charger of the motor vehicle in order to transmit to the motor vehicle the electrical current necessary to recharge it.

In the second embodiment, which is that for which the electric shock preventer 30 and the retaining cylinder 14 form a one-piece component, the assembly method comprises a step of overmolding this electric shock preventer 30 and this retaining cylinder 14. In the same way as for the first embodiment, the electric shock preventer may be produced either with slits 42 of an increasing width, as can be seen particularly clearly in FIG. 5, or with slits 42 of a constant width, as illustrated in FIG. 6. The assembly method subsequently comprises a step of inserting the one-piece assembly thus formed by the electric shock preventer 30 and the retaining cylinder 14 into the cylindrical cavity 12 of the plug fitting 2, and then an insertion step during which the electrical connector 16 is itself inserted into the one-piece assembly. The prong 17 can then be inserted through the electric shock preventer 30 to come into contact with the bosses 28 of the electrical connector 16, and thus make it possible to electrically recharge the vehicle.

The present invention therefore provides an electrical charging plug having an electric shock preventer, which makes it possible to create a physical barrier between an electrical connector of the electrical charging plug and a user's finger, without obstructing the electrical contact between this electrical connector and a prong of a complementary electrical socket of a motor vehicle.

The present invention, however, is not limited to the means and configurations described and illustrated here and it also extends to any equivalent means and configurations and to any technically feasible combination of such means.

1-14. (canceled)

15. An electrical charging plug for a motor vehicle, comprising:
a plug fitting with a coupling side, an interface side, and at least one cylindrical cavity extending mainly in a longitudinal direction and passing through the plug fitting from the coupling side to the interface side;
a retaining cylinder disposed in the cylindrical cavity;
an electrical connector disposed in the retaining cylinder, an end of the electrical connector being adjacent to the coupling side; and
an electric shock preventer associated with the end of the electrical connector and comprising a peripheral portion and a diaphragm, the electric shock preventer being configured to have a protection position in which the diaphragm is substantially flat and a coupling position in which the diaphragm is deformed toward an interior of the retaining cylinder.

16. The electrical charging plug as claimed in claim 15, wherein the electric shock preventer is disposed, in the longitudinal direction, between the retaining cylinder and a wall of the cylindrical cavity that faces the end of the electrical connector.

17. The electrical charging plug as claimed in claim 15, wherein the electric shock preventer and the retaining cylinder form a one-piece assembly.

18. The electrical charging plug as claimed in claim 15, wherein the electrical connector has a tubular shape with an internal face and an external face, the internal face being equipped with bosses configured to be in contact with a prong of an electrical charger, the bosses being disposed at a distance from the end associated with the electric shock preventer.

19. The electrical charging plug as claimed in claim 18, wherein, in the coupling position, the diaphragm is at a distance from the bosses.

20. The electrical charging plug as claimed in claim 19, wherein the diaphragm comprises slits configured to deform when the prong of the electrical charger passes through.

21. The electrical charging plug as claimed in claim 20, wherein the diaphragm comprises a central opening, the slits extending in the shape of a star from the central opening.

22. The electrical charging plug as claimed in claim 21, wherein the slits widen as they get further away from the central opening.

23. The electrical charging plug as claimed in claim 21, wherein the slits have a constant width as they get further away from the central opening.

24. The electrical charging plug as claimed in claim 15, wherein the

25. The electrical charging plug as claimed in claim 15, wherein the electrical charging plug includes a plurality of the retaining cylinder, each of which contains the electrical connector, each retaining cylinder being connected, on the interface side, to at least one other retaining cylinder by a connecting tab.

26. The electrical charging plug as claimed in claim 25, wherein the connecting tab extends in a slot of the interface side.

27. A method for assembling the electrical charging plug as claimed in claim 16, comprising:
inserting the electric shock preventer into the cylindrical cavity of the plug fitting;
inserting the retaining cylinder into the cylindrical cavity; and
clamping including pressing the electric shock preventer against the wall of the cylindrical cavity by the retaining cylinder.

28. A method for assembling the electrical charging plug as claimed in claim 17, comprising:
overmolding the electric shock preventer with the retaining cylinder; and
inserting an assembly formed by the retaining cylinder and the electric shock preventer into the cylindrical cavity of the plug fitting.
